(19) United States
(12) Patent Application Publication
(10) Pub. No.: US 2016/0042277 A1
(43) Pub. Date: Feb. 11, 2016

(54) SOCIAL ACTION AND SOCIAL TIE PREDICTION

(71) Applicant: HEWLETT-PACKARD DEVELOPMENT COMPANY, LP, Fort Collins, CO (US)

(72) Inventors: Xiaofeng YU, Beijing (CN); Jun Qing Xie, Beijing (CN)

(73) Assignee: HEWLETT-PACKARD DEVELOPMENT COMPANY, LP, Fort Collins, CO (US)

(21) Appl. No.: 14/452,135

(22) Filed: Aug. 5, 2014

(51) Int. Cl. G06N 5/04; H04L 29/08

(52) U.S. Cl. CPC G06N 5/04; H04L 67/22

(57) ABSTRACT

Example implementations relate to predicting social actions and social ties of users in a social network. For example, a computing device may include a processor. The processor may access social network data associated with a set of users of a social network. The processor may also parse social action data and social tie data from the social network data and calculate a set of parameters defining relationships between the social action data and the social tie data. The processor may further determine, using the set of parameters, a social action and a social tie associated with a particular user of the social network.

### BACKGROUND

The use of online social networking services has grown, providing a bridge between activities occurring in daily physical life and the virtual Internet space. The popularity of social networking sites has attracted billions of active users, resulting in the availability of large amounts of data associated with these users. Data from social networking services may be useful for a variety of applications (e.g., crowdsourcing).

### BRIEF DESCRIPTION OF THE DRAWINGS

Some examples of the present application are described with respect to the following figures:

FIG. 1 is a block diagram of an example computing device for predicting social actions and social ties associated with users of a social network;

FIG. 2 is a flowchart illustrating an example method of predicting social actions and social ties;

FIG. 3 is a diagram of an example social network of users and their corresponding social actions and social ties;

FIG. 4 is a diagram of an example three-dimensional graphical representation of a mutual latent random graph corresponding to the example social network of FIG. 3;

FIG. 5A is a graph of an example comparison of performance for social action predictions in a social network; and

FIG. 5B is a graph of an example comparison of performance for social tie predictions in a social network.

### DETAILED DESCRIPTION

As described above, the popularity of social networking sites has resulted in the availability of large amounts of data associated with users. Analysis of the available data may be useful in modeling and predicting the social actions and the social ties of a user of a social network. A social action of a user is a social network action, activity, behavior, status, membership, preference, or characteristic associated with the user. Examples of social actions of a user include posting a comment, specifying a particular location of the user, specifying a particular favorite food, an activity status of the user, a membership or preference of a user, and the like. A social tie associated with a user is a type of relationship between two or more individual users of a social network. Examples of social ties include a familial relationship, a work relationship (e.g., colleague), a friendship, a classmate relationship, and the like. Social action and social tie predictions may be used to present relevant content to a user. For example, a service in which a user may likely be interested may be presented to a user based on a social action and social tie prediction. The presentation of relevant content to a user may improve the user's experience and may boost revenue for social media sites.

Social tie prediction may be useful for tapping into the wisdom of crowds to aid in making more informed decisions. Because individual users are socially connected on a social network, social influence may result from information diffusion in the social network. Social influence may occur when a user's opinions and/or behaviors are affected by other users. Different types of social ties may have different influences on social actions. For example, a user's trusted friends on a social network may affect the user's online behavior. Additionally, social actions may also influence social ties. For example, users with similar preferences may be more likely to be friends on a social network than other users with different preferences. In another example, a user with momentous activities (e.g., an actor or singer) may attract more people who wish to connect with that user than a user with trivial activities. These dynamics between social actions and social ties are known as the social phenomenon of homophily, which is the idea that people tend to follow the behaviors of their friends and tend to create relationships with other people who are already similar to them. Homophily suggests that both social actions and social ties are bi-directionally correlated and mutually influenced in social media, and this correlation may be mutually reinforced if modeled jointly.

A unified mutual latent random graph (MLRG) framework based on exponential-family random graph models may be used to explore homophily for simultaneous social action and social tie prediction. This MLRG framework may incorporate shared latent factors associated with users, users' behaviors, and users' relationships. The MLRG framework may also define coupled models to encode both social action and social tie data to capture dynamics and mutual influence.

The MLRG framework may include a gradient-based learning algorithm for learning and optimizing predictive parameters defining social action data, social tie data, and relationships between the social action data and the social tie data. The learning algorithm efficiently explores social actions, social ties, as well as dependencies and interactions between the social actions and social ties. By coupling social actions and social ties jointly in a unified framework, improved performance of social action and social tie prediction is achieved.

To predict social actions and social ties for users of a social network, social network data may be accessed for a portion of users of the social network. A model may be generated to define the distributions associated with social actions and social ties parsed from the social network data as well as the relationships between the social action data and the social tie data. This model may be used to analyze the social network data for the portion of users for which data was accessed such that the mutual influences and relationships between the social actions and the social ties may be determined. The gradient-based learning algorithm may be used to optimize a set of parameters defining social action data, social tie data, and relationships between the social action a data and the social tie data. The optimized parameters may be used to predict social actions and social ties associated with other users of the social network. These predictions may be used in any relevant context and/or application, such as targeted advertising, content suggestions, and the like.

For example, the MLRG framework may be applied to a social network to determine that there is a correlation between a social tie that indicates a work relationship and a social action that indicates an affinity for sandwiches. This determination may be used to predict social actions and social ties for users of the social network. In some examples, the social actions and social ties may be predicted simultaneously. For example, if User A and User B are work colleagues and User A likes sandwiches, it may be likely that User B also likes sandwiches based on the MLRG framework analysis. In this case, a targeted advertisement for a new sandwich shop may be presented to User B.

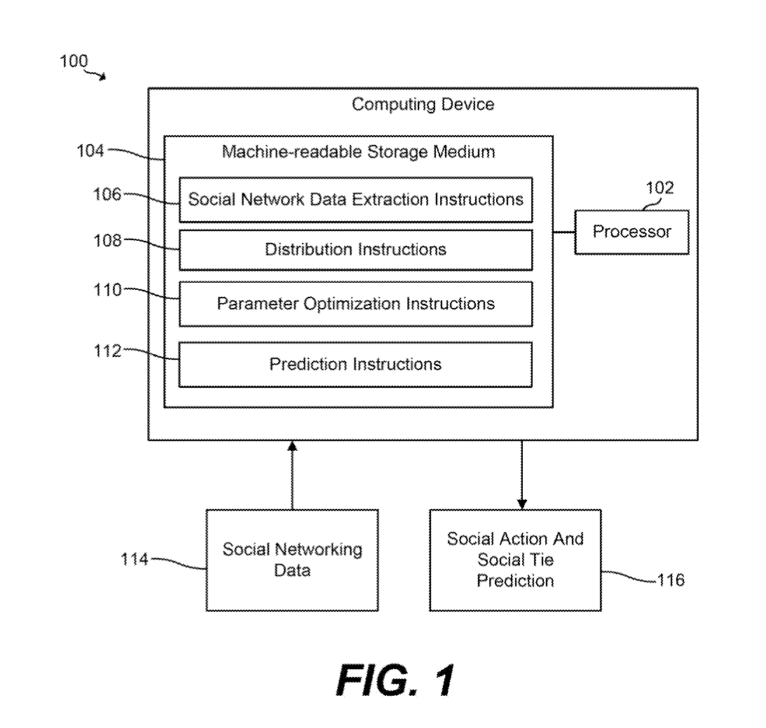

Referring now to the figures, FIG. 1 is a block diagram of an example computing device 100 for predicting social actions and social ties associated with users of a social network. As used herein, a social network may be any online social networking service allowing users to connect and communicate with one another.

Computing device 100 may be, for example, a web-based server, a local area network server, a cloud-based server, a notebook computer, a desktop computer, an all-in-one system, a tablet computing device, a mobile phone, an electronic book reader, or any other electronic device suitable for predicting social actions and social ties associated with users of a social network. Computing device 100 may include a processor 102 and a machine-readable storage medium 104. Computing device 100 may be in communication with and/or may be part of one or more social networks. Computing device 100 may access social networking data 114 from a social network and may provide a social action and social tie prediction 116.

Processor 102 may be a central processing unit (CPU), a semiconductor-based microprocessor, and/or other hardware devices suitable for retrieval and execution of instructions stored in machine-readable storage medium 104. Processor 102 may fetch, decode, and execute instructions 106, 108, 110, and 112 to control a process of predicting social actions and social ties associated with users of a social network. As an alternative or in addition to retrieving and executing instructions, processor 102 may include at least one electronic circuit that includes electronic components for performing the functionality of instructions 106, 108, 110, 112, or a combination thereof.

Machine-readable storage medium 104 may be any electronic, magnetic, optical, or other physical storage device that contains or stores executable instructions. Thus, machine-readable storage medium 104 may be, for example, Random Access Memory (RAM), an Electrically Erasable Programmable Read-Only Memory (EEPROM), a storage device, an optical disc, and the like. In some examples, machine-readable storage medium 104 may be a non-transitory storage medium, where the term “non-transitory” does not encompass transitory propagating signals. As described in detail below, machine-readable storage medium 104 may be encoded with a series of processor executable instructions 106, 108, 110, and 112 for accessing social network data 114 associated with a set of users of a social network, parsing social action data and social tie data from the social network data 114, calculating (e.g., optimizing) a set of parameters defining social actions, social ties, and relationships between the social action data and the social tie data, and determining (e.g., simultaneously) a social action and a social tie associated with a particular user of the social network using the set of optimized parameters.

Social network data extraction instructions 106 may request, access, receive, or pull social network data 114 from a social network in communication with computing device 100. The social network data 114 may be associated with a set of users of the social network and may include any relevant data associated with the set of users, including data associated with social actions of the users and social ties of the users. Social network data extraction instructions 106 may extract, parse, or determine social action data and social tie data from the social network data 114 received from the social network.

Distribution instructions 108 may specify distributions associated with social actions, social ties, and the relationships between social actions and social ties. These distributions may be used to generate a MLRG that may be used to model the social actions, social ties, and the relationships between social actions and social ties.

Parameter optimization instructions 110 may use the social action data and social tie data extracted by the social network data extraction instructions 106 and the distributions specified by the distribution instructions 108 to determine, characterize, generalize, calculate, optimize, or model mutual influences and relationships between the social action data and the social tie data for the social network. This may include determining one or more latent factors associated with relationships between the social action data and the social tie data and/or determining, generating, calculating, or optimizing a set of parameters defining the mutual influences and relationships between the social action data and the social tie data.

Prediction instructions 112 may use the set of parameters calculated by the parameter optimization instructions 110 to predict, determine, or calculate a social action and/or a social tie associated with other users of the social network. In some examples, the social action and social tie may be predicted simultaneously. For example, prediction instructions 112 may use the models and/or the parameters calculated by the parameter optimization instructions 110 to predict a social action and/or a social tie for a particular user of the social network. Prediction instructions 112 may provide relevant content and/or information to the particular user based on the social action and/or social tie predicted. For example, prediction instructions 112 may use the calculated parameters to predict that the particular user may be interested in and/or responsive to a particular product suggestion and may present the product suggestion to the user accordingly.

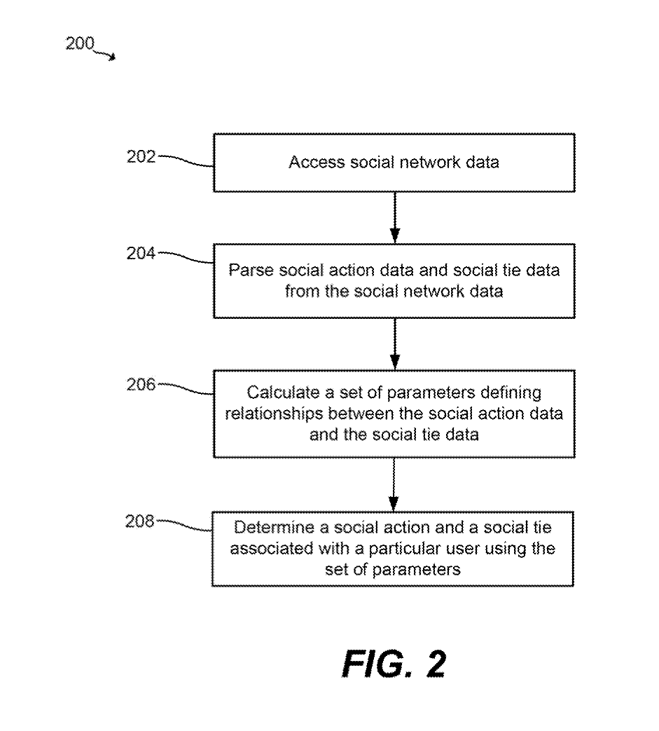

FIG. 2 is a flowchart illustrating an example method 200 of predicting social actions and social ties. Method 200 may be implemented using computing device 100 of FIG. 1.

Method 200 includes, at 202, accessing social network data. The social network data may be accessed from a social network and may be associated with a set of users of the social network. For example, social network data associated with a portion of users of a social network may be accessed by computing device 100 of FIG. 1.

Method 200 also includes, at 204, parsing social action data and social tie data from the social network data. For example, social action data that specifies characteristics, preferences, and/or actions associated with users of the set of users may be parsed from the social network data, and social tie data that specifies particular types of connections between users of the set of users may be parsed from the social network data.

Method 200 also includes, at 206, calculating a set of parameters defining relationships between the social action data and the social tie data. The set of parameters may also define social action data and social tie data. The calculation of the set of parameters may include optimizing the set of parameters defining the relationships. The relationships defined by the set of parameters may include mutual influences between the social actions of the social action data and the social ties of the social tie data.

Method 200 also includes, at 208, determining a social action and a social tie associated with a particular user of the social network using the set of parameters. For example, a social action and a social tie associated with a particular user may be predicted and used for providing any relevant content and/or information that the particular user may find interesting. In another example, a social action and a social tie associated with a particular user may be predicted and used for providing any relevant content and/or information that a social network friend of the particular user may find interesting. Social actions and social ties may be predicted for a plurality of users of the social network using the set of parameters. In some examples, social actions and social ties may be predicted simultaneously.

The following example definitions of variables within the social network context may be used to model the influences between social actions and social ties of the social network. In this example, let G=(V, E) be a social network graph, where V={v₁, v₂, . . . , v_{N}} is the set of |V|=N users and E={e₁₁, e₁₂, . . . , e_{M}}⊂V×V is the set of |E|=M connections between users. Let y={y₁, y₂, . . . , y_{N}}(yᵢεY) be the set of actions associated with N users, and s={s₁₁, s₁₂, . . . , s_{N}}(sᵢⱼεS) be the set of corresponding social tie labels associated with M connections. The connection eᵢⱼ (1≦i, j≦N, i≠j) between vᵢ and vⱼ may be directed or undirected. For consistency, sᵢⱼ≠sᵢⱼ and sᵢⱼ=sᵢⱼ may be valid settings. Given the observed social network data D constructing graph G, the likely types of actions y* and ties s* may be simultaneously detected such that both actions y* and ties s* are optimized.

In this example, to characterize the social action yᵢ, assume that for the user vᵢ there exists observable attributes or properties mᵢ, such as, for example, the user's registration information, historical actions, and the like. Further, assume for this example that there exists some hidden or latent properties xᵢⱼ for vᵢ. These latent properties or factors are implicit and are not directly observable. Examples of these latent factors may include the influence from social ties and the like. Observable factors may be denoted as φ(yᵢ, vᵢ, mᵢ), and latent or hidden factors may be denoted as φₕ(yᵢ, sᵢⱼ, xᵢⱼ). Given the graph G, the probability distribution of yᵢ depends on both observable and latent factors as follows:
P_{yi|G}˜φ(yᵢ, vᵢ, mᵢ)
P_{yi|G}˜φₕ(yᵢ, sᵢⱼ, xᵢⱼ)
P_{yi|G}˜φ(yᵢ, vᵢ, mᵢ)φₕ(yᵢ, sᵢⱼ, xᵢⱼ)
   This modeling integrates two types of factors for both observable and latent properties to capture both user-behavior dependencies as well as the influence from social ties when exploring social actions.

Continuing this example, to characterize the social tie sᵢⱼ between user pair (vᵢ, v₁), assume that there exist observable properties wᵢⱼ, such as the posterior probability of the social tie sᵢⱼ assigned to (v, vᵢ). Observable factors φ′(sᵢⱼ, vᵢ, vⱼ, wᵢⱼ) may be denoted for wᵢⱼ. Similarly, further assume that there exist some latent properties to incorporate the social action influence on social ties. For consistency, the vector xᵢⱼ may be used to represent the latent properties, and the latent factor φₕ(yᵢ, sᵢⱼ, xᵢⱼ) may be used to capture the social action influence on social ties. Both xᵢⱼ and φₕ(yᵢ, sᵢⱼ, xᵢⱼ) are utilized in encoding social action dependency and social tie connection simultaneously. As such, φₕ(yᵢ, sᵢⱼ, xᵢⱼ) exposes influences from social ties for modeling social actions and also exposes influences from social actions for modeling social ties. By doing so, the latent factor φₕ(yᵢ, sᵢⱼ, xᵢⱼ) is bi-directionally coupled, encoding both sources of evidence and exploring mutual influences and dynamics between social actions and social ties, resulting in improved prediction performance. Given the user action yᵢ and the graph G, the following model may be used for the probability distribution of sᵢⱼ and may depend on both observable and latent factors:
P_{sij|(yi, G)}˜φ′(sᵢⱼ, vᵢ, vⱼ, wᵢⱼ)
P_{sij|(yi, G)}˜φₕ(yᵢ, sᵢⱼ, xᵢⱼ)
P_{sij|(yi, G)}˜φ′(sᵢⱼ, vᵢ, vⱼ, wᵢⱼ)φₕ(yᵢ, sᵢⱼ, xᵢⱼ)

The mutual correlation between social actions and social ties advocates joint modeling of both sources of evidence in a single unified framework. Based on the above descriptions, a MLRG based on exponential-family random graph models (ERGMs) may be defined. To design a concrete model, distributions for the dependencies for MLRGs may be specified. According to the Hammersley-Clifford theory, the joint conditional distribution P_{(yi, sij)|G} is factorized as a product of potential functions over all cliques in the graph G, and as such, the MLRG may be summarized as follows:
∀yᵢεY P_{yi|G}˜φ(yᵢ, vⱼ, mᵢ)φₕ(yᵢ, sᵢⱼ, xᵢⱼ)
∀sᵢⱼεS P_{sij|(yi, G)}˜φ′(sᵢⱼ, vᵢ, vⱼ, wᵢⱼ)φₕ(yᵢ, sᵢⱼ, xᵢⱼ)
∀yᵢεY, ∀sᵢⱼεS P_{(yi, sij)|G}˜φ(yᵢ, vⱼ, mᵢ)φₕ(yᵢ, sᵢⱼ, xᵢⱼ)φ′(sᵢⱼ, vᵢ, vⱼ, wᵢⱼ)
   As such, the model includes three factors: the factor φ(yᵢ, vⱼ, mᵢ) measuring dependencies of the social action yᵢ conditioned on G, the factor φ′(sᵢⱼ, vᵢ, vⱼ, wᵢⱼ) measuring the social tie sᵢⱼ between two arbitrary users vᵢ and vⱼ in G, and the latent factor φₕ(yᵢ, sᵢⱼ, xᵢⱼ) exposing mutual influences between the social action yᵢ and social tie sᵢⱼ.

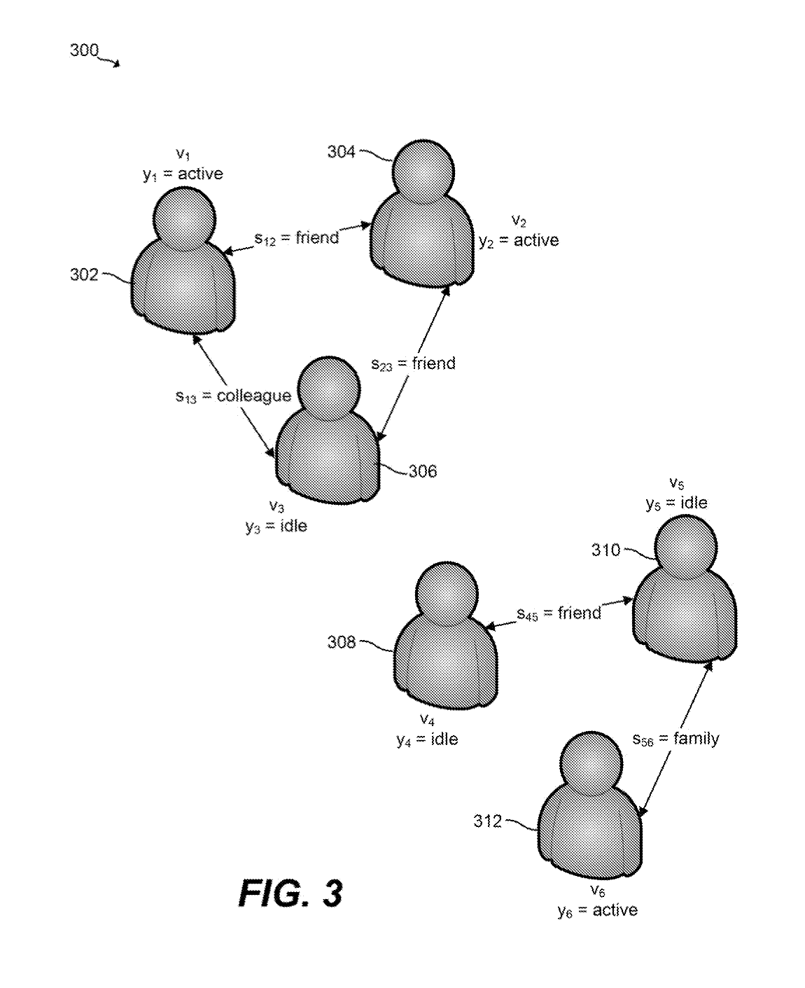

The three factors φ(•), φₕ(•), and φ′(•) may be instantiated in various ways. In some examples, each factor is defined as the exponential family of an inner product over sufficient statistics (e.g., feature functions) and corresponding parameters. Each factor is a clique template whose parameters are tied. FIG. 3 is a diagram of an example social network 300 of users 302, 304, 306, 308, 310, 312 and their corresponding social actions and social ties. In FIG. 3, the example social network 300 includes a set of users V={v₁ 302, v₂ 304, v₃ 306, v₄ 308, v₅ 310, v₆ 312} each associated with a particular social action from the set of social actions Y={active, idle}, where the users 302, 304, 306, 308, 310, 312 are connected to each other based on a set of social ties S={friend, colleague, family}. For example, user v₁ 302 is associated with an active social action yᵢ and is connected to user v₂ 304 based on the friend social tie s₁₂.

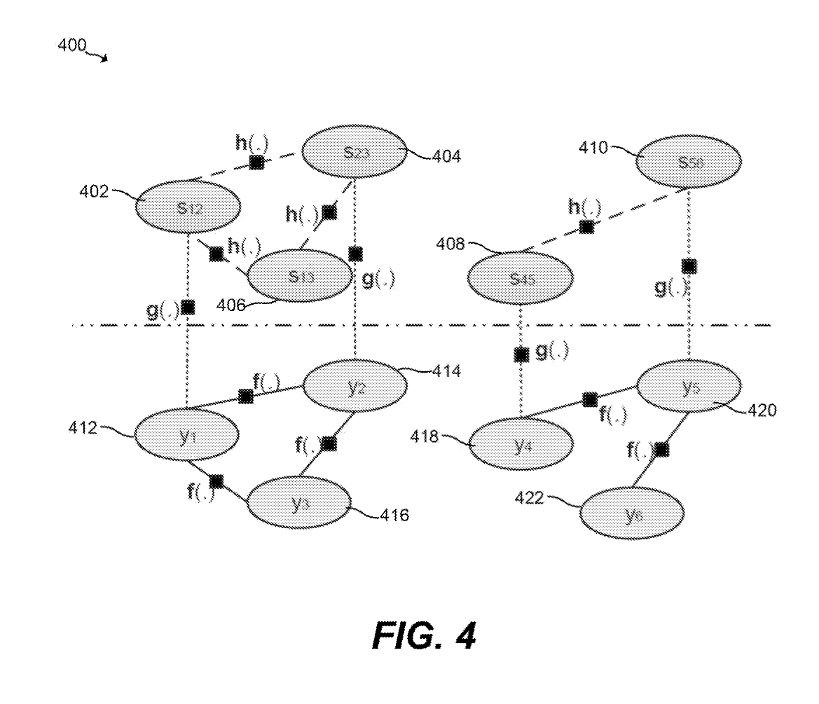

FIG. 4 is a diagram of an example three-dimensional graphical representation of a MLRG 400 corresponding to the example social network 300 of FIG. 3. The functions f(•) model dependencies between social actions 412, 414, 416, 418, 420, 422, and the functions h(•) model dependencies between social ties 402, 404, 406, 408, 410. Additionally, the functions g(•) capture relationships between social actions and social ties, such as mutual influences and dependencies between social actions and social ties. This modeling provides a formalism for discovering bi-directional dependencies and interactions between social actions and social ties to capture their mutual influences and relationships. This modeling also provides flexibility to incorporate a collection of arbitrary, overlapping, and non-independent features.

Unlike conventional techniques, the MLRG model described herein may define latent factors to assume mutual and dynamic interactions between social ties and social actions. Additionally, the MLRG model provides a single unified framework to address both social action prediction and social tie inference simultaneously while utilizing both sources of evidence.

The MLRG model is a learning model that may be used to estimate a parameter configuration Θ={α, β, γ} such that the log-likelihood of observation is maximized. The log-likelihood objective function O(Θ) of the observation, given the graph G, may be defined as:

$$𝒪 ( Θ ) = log {P}_{( y , s ) \vert 𝒢} - log Ω ( Θ ) = log [ exp \{ {\sum }_{{y}_{i} ∈ 𝒴 , {s}_{ij} ∈ 𝒮} Θ q ( {y}_{i} , {s}_{ij} ) \} ] - log Z - log Ω ( Θ )$$

where Ω(Θ) is regularization to reduce over-fitting. In some examples, a spherical Gaussian prior with mean 0 and covariance δ²I may be used. Ω(Θ) and Θq may be defined as follows:

$$Ω ( Θ ) = {\sum }_{{y}_{i} ∈ 𝒴} \frac{{α}^{2}}{2 {σ}^{2}} + {\sum }_{{y}_{i} ∈ 𝒴 , {s}_{ij} ∈ 𝒮} \frac{{β}^{2}}{2 {σ}^{2}} + {\sum }_{{s}_{ij} ∈ 𝒮} \frac{{γ}^{2}}{2 {σ}^{2}}$$

$$Θ q ( {y}_{i} , {s}_{ij} ) = α f ( {y}_{i} , {υ}_{i} , {m}_{i} ) + β g ( {y}_{i} , {s}_{ij} , {x}_{ij} ) + γ h ( {s}_{ij} , {υ}_{i} , {υ}_{j} , {w}_{ij} )$$

A mutual gradient descent (MGD) algorithm may be used to estimate the parameters efficiently in a mutual and collaborative manner. An example of a MGD algorithm is as follows:

Input: The social graph [symbol] , number of iterations n, and the learning
rate η.
Output: Optimized parameters θ′ = {α*, β*, γ*},
while equilibrium states or a threshold number of iterations are not
reached do

| \| | repeat | |
|---|---|---|
| \| | \| | Choose a random example (yᵢ, sᵢⱼ) ∈ [symbol] ; |
| \| | \| | Optimize social action parameters α and β: |
| \| | \| | |
| \| \| \| | \| \| \| | $Compute the approximated gradients \frac{\partial {θ}^{′}}{\partial α} and \frac{\partial {θ}^{′}}{\partial β}$ |
| \| | \| | |
| \| | \| | and perform stochastic approximation; |
| \| | \| | Update α and β with learning rate η: |
| \| | \| | |
| \| \| \| | \| \| \| | $α ← α - η \cdot \frac{\partial {θ}^{′}}{\partial α} , β ← β - η \cdot \frac{\partial {θ}^{′}}{\partial β} .$ |
| \| | \| | |
| \| | \| | //Explore social tie influence |
| \| | \| | Optimize social tie parameters γ and β: |
| \| | \| | |
| \| \| \| | \| \| \| | $Compute the approximated gradients \frac{\partial {θ}^{′}}{\partial γ} and \frac{\partial {θ}^{′}}{\partial β}$ |
| \| | \| | |
| \| | \| | and perform stochastic approximation; |
| \| | \| | Update γ and β with learning rate η: |
| \| | \| | |
| \| \| \| | \| \| \| | $γ ← γ - η \cdot \frac{\partial {θ}^{′}}{\partial γ} , β ← β - η \cdot \frac{\partial {θ}^{′}}{\partial β} .$ |
| \| | \| | |
| \| | \| | //Explore social action influence |

| | |
|---|---|
| \| | until converge; |

end
return α*, β*, and γ*

Once the social action parameters α and β are optimized using the MGD algorithm, the influences and hypotheses of the social actions may aid in the learning of the social tie parameters γ and β, and vice versa. As shown in the example MGD algorithm above, β is a coupled parameter vector for both social actions and social ties and may be updated twice in each iteration of the MGD algorithm. By doing so, the MGD algorithm allows for learning of social action parameters to capture social tie influences and also optimizes social tie parameters to alleviate social action influences. This learning algorithm may run iteratively until convergence to enhance the optimization of social actions and social ties.

In some examples, each iteration of the MGD algorithm may include using an example sample of users at random and accordingly applying parameter updates by moving in the direction defined by the stochastically-approximated gradient of the loss function. This algorithm is computationally efficient, and convergence is fast when the training examples are redundant since only a few examples are used during performance. Furthermore, in some examples, the MGD algorithm may be online and may scale sub-linearly with the amount of training data, making it useful for large-scale datasets.

The MGD algorithm may compute approximations of the gradients due to the intractability of the normalizing constant Z in the log-likelihood of the MLRG model. The MGD algorithm optimizes social action and social tie parameters (e.g., α, β, γ) simultaneously, providing a scalable technique applicable to real-world problems. Additionally, the MGD algorithm may perform mutual and collaborative optimization to enable mutual influence between social actions and social ties.

Inference may be used to find the likely types of actions y* and corresponding social tie labels s* as follows: (y*, s*)=arg max_{(y, s)} P_{(y, s|G)}. Based on the learned parameters Θ*={α*, β*, γ*}, the label of each social action yᵢ is predicted by finding a labeling assignment that maximizes P_{yi|G} as yᵢ* arg max_{yiεY} P_{yi|G}. The social tie label sᵢⱼ is inferred such that sᵢⱼ*=arg max_{sijεS} P_{sij|(yi, G)}.

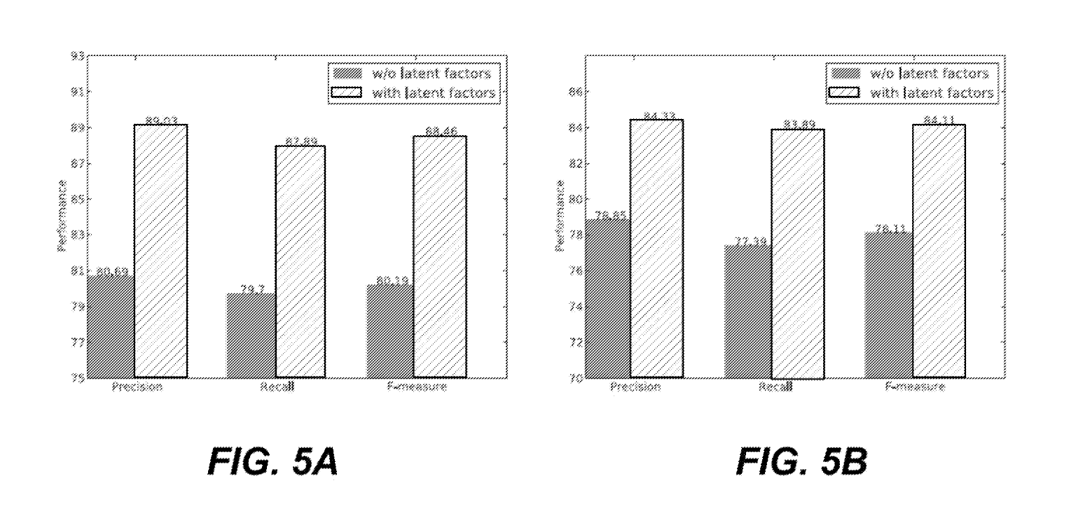

In one example, the above-described techniques were used for a popular social network that allows users to check in at a physical location and let their social network friends know where they are. The dataset included 11,326 distinct users, 182,968 physical locations (e.g., venues), 1,385,233 check-in behaviors, and 47,164 social connections from January 2011 to July 2011. The nature and effectiveness of the associated latent factors on the mutual influences were examined. FIG. 5A is a graph of an example comparison of performance for social action predictions in a social network. FIG. 5B is a graph of an example comparison of performance for social tie predictions in a social network. The graphs of FIG. 5A and FIG. 5B show the differences in performance when latent factors are considered. The latent factors consistently enhance precision, recall, and F-measure for both social action and social tie prediction. For example, the latent factors improve the F-measure by 8.27% (from 80.19% to 88.46%) for social action prediction and improve the F-measure by 6.0% (from 78.11% to 84.11%) for social tie prediction.

Examples provided herein (e.g., methods) may be implemented in hardware, software, or a combination of both. Example systems may include a controller/processor and memory resources for executing instructions stored in a tangible non-transitory medium (e.g., volatile memory, non-volatile memory, and/or machine-readable media). Non-transitory machine-readable media can be tangible and have machine-readable instructions stored thereon that are executable by a processor to implement examples according to the present disclosure.

An example system can include an/or receive a tangible non-transitory machine-readable medium storing a set of machine-readable instructions (e.g., software). As used herein, the controller/processor can include one or a plurality of processors such as in a parallel processing system. The memory can include memory addressable by the processor for execution of machine-readable instructions. The machine-readable medium can include volatile and/or non-volatile memory such as a random access memory (“RAM”), magnetic memory such as a hard disk, floppy disk, and/or tape memory, a solid state drive (“SSD”), flash memory, phase change memory, and so on.

What is claimed is:

1. A computing device comprising:
a processor to:
access social network data associated with a set of users of a social network;
parse social action data and social tie data from the social network data;
calculate a set of parameters defining relationships between the social action data and the social tie data; and
determine, using the set of parameters, a social action and a social tie associated with a particular user of the social network.

2. The computing device of claim 1, wherein the social tie data specifies particular types of connections between users in the set of users.

3. The computing device of claim 1, wherein the social action data specifies characteristics, preferences, or actions associated with users in the set of users.

4. The computing device of claim 1, wherein the processor is further to provide relevant information to the particular user based on the social action and the social tie.

5. The computing device of claim 1, wherein the processor is further to provide relevant information to a friend of the particular user based on the social action and the social tie.

6. The computing device of claim 1, wherein the processor is further to determine social actions and social ties for a plurality of users being different from the set of users.

7. The computing device of claim 1, wherein the processor is further to:
specify distributions associated with the relationships between the social action data and the social tie data;
generate a mutual latent random graph based on the distributions; and
using the mutual latent random graph, determine at least one latent factor associated with the relationships between the social action data and the social tie data, the set of parameters being calculated based on the mutual latent graph and the at least one latent factor.

8. The computing device of claim 1, wherein the set of parameters includes parameters associated with the social action data, parameters associated with social tie data, and parameters associated with the relationships between the social action data and the social tie data.

9. The computing device of claim 1, wherein the processor is further to optimize the set of parameters based on a mutual gradient descent algorithm.

10. A method comprising:
receiving, by a computing device, social network data associated with a set of users of a social network;
extracting, by the computing device, social action data and social tie data from the social network data;
generating, by the computing device, a set of parameters defining relationships between the social action data and the social tie data; and
predicting, by the computing device, a social action and a social tie associated with a particular user of the social network including predicting the social action and the social tie using the set of parameters.

11. The method of claim 10, wherein the social tie data specifies particular types of connections between users in the set of users.

12. The method of claim 10, wherein the social action data specifies characteristics, preferences, or actions associated with users in the set of users.

13. The method of claim 10, further comprising:
providing relevant information to the particular user based on the social action and the social tie.

14. The method of claim 10, further comprising:
providing relevant information to a friend of the particular user based on the social action and the social tie.

15. The method of claim 10, further comprising:
specifying distributions associated with the relationships between the social action data and the social tie data;
generating a mutual latent random graph based on the distributions; and
using the mutual latent random graph, determining at least one latent factor associated with the relationships between the social action data and the social tie data, the set of parameters being generated based on the mutual latent random graph and the at least one latent factor.

16. A non-transitory machine-readable storage medium storing instructions that, if executed by at least one processor of a computing device, cause the computing device to:
access social network data associated with a set of users of a social network;
extract social action data and social tie data from the social network data;
determine relationships between the social action data and the social tie data;
optimize a set of parameters defining the relationships between the social action data and the social tie data; and
predict, using the set of parameters, a social action and a social tie associated with a particular user of the social network.

17. The non-transitory machine-readable storage medium of claim 16, wherein the social tie data specifies particular types of connections between users in the set of users.

18. The non-transitory machine-readable storage medium of claim 16, wherein the social action data specifies characteristics, preferences, or actions associated with users in the set of users.

19. The non-transitory machine-readable storage medium of claim 16, wherein the instructions, if executed by the at least one processor, further cause the computing device to provide relevant information to the particular user based on the social action and the social tie.

20. The non-transitory machine-readable storage medium of claim 16, wherein the instructions, if executed by the at least one processor, further cause the computing device to provide relevant information to a friend of the particular user based on the social action and the social tie.
